(19) United States
(12) Patent Application Publication
(10) Pub. No.: US 2007/0242046 A1
(43) Pub. Date: Oct. 18, 2007

(54) Computer Pointing Device with Pliable Outer Shell Having Memory of Original Form

(76) Inventor: Scot H. Weiss, Orlando, FL (US)

Correspondence Address: Terry M. Sanks;Beusse Wolter Sanks Mora & Maire, P.A., 390 North Orange Avenue, Suite 2500, Orlando, FL, 32801, US

(21) Appl. No.: 11/736,968

(22) Filed: Apr. 18, 2007

Related U.S. Application Data
(60) Provisional application No. 60/792,887, filed on Apr. 18, 2006.

(51) Int. Cl. G09G 5/08

(52) U.S. Cl. 345/163

(57) ABSTRACT

A computer peripheral, including a body, a surface on the body having at least a part of the surface that conforms to an external force applied to the surface and returns to an original shape once the external force is removed, at least one control element disposed at a first location upon the surface, and a directional determining device disposed at a second location upon the surface.

### CROSS-REFERENCE TO RELATED APPLICATION

The present application is based on U.S. Provisional Application No. 60/792,887 filed Apr. 18, 2006.

### FIELD OF INVENTION

The present invention relates to a computer peripheral, and more specifically, to a hand-held computer pointer that has a pliable cover that takes a form of a user's hand and then can return to an original form once the hand has been removed.

### BACKGROUND OF THE INVENTION

Computer peripherals are used to enter commands into a computer. One such peripheral is known as a computer mouse, and/or computer pointing device. The computer mouse typically includes a body or top portion upon which a user rests a hand, two or three depressible control buttons integral to the body, and a bottom portion or base which contains motions sensing device. Electronics are located within the body.

Other computer peripherals that are operated by the user's hand are also currently in existence. For example, computer gaming controller exist. These devices are usually configured to allow the user to grasp the controller. The pressure at which the user grasps the controller may vary based on the user's excitement and level of intensity when playing a computer game.

Other pointing devices are also available. Track ball peripherals are in existence where the user no longer moves a mouse along a surface. Instead the user rotates a ball to command the cursor on a computer screen. There are also peripherals that include both the track ball peripheral and the traditional mouse peripheral in a single embodiment.

In each computer peripheral where a hand is used, injury may result from prolong use. Such injuries are usually the result of the surface of the peripheral being rigid and/or nearly rigid wherein the surface does not give way when the user applies a hand. Individuals who spend numerous hours using such peripherals would benefit from a device that could reduce the risk of injury due to using computer peripherals.

### BRIEF DESCRIPTION OF THE INVENTION

Exemplary embodiments of the invention disclose a device that has a pliable outer cover that takes a form of a user's hand and then returns to an original form once the hand is removed. A computer peripheral is disclosed. The computer peripheral includes a body and a surface on the body having at least a part of the surface that conforms to an external force applied to the surface and returns to an original shape once the external force is removed. At least one control element disposed at a first location upon the surface is also provided. A directional determining device is also provided and is disposed at a second location upon the surface.

In another exemplary embodiment another computer peripheral is disclosed. The peripheral includes a main body having at least a first part, a second part and a bottom. A control element is disposed at the first part of the main body. A moldable surface is provided as part of the second part. The moldable surface conforms to a hand placed upon the main body and returns to an original shape when the hand is removed.

In yet another exemplary embodiment of the invention A computer peripheral is disclosed having a cover structure upon which a hand is placed that is moldable to a contour of the hand when the hand is placed upon the peripheral and then returns to an original form of the cover structure when the hand is removed from the peripheral.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 depicts an exemplary embodiment of a computer peripheral with memory foam on its outer surface;

FIG. 2 depicts an exemplary embodiment of the present invention with a hand in place; and

FIG. 3 depicts an exemplary embodiment of another computer pointing device with memory foam preformed in a particular configuration.

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

Though exemplary embodiments of the present invention are described with respect to a computer mouse, those skilled in the art will recognize that exemplary embodiments are applicable to other computer peripherals as well. For example, trackball peripherals, game controllers, etc., may also include exemplary embodiments of the invention in their construction. Towards this end, when discussing computer peripherals and computer mouse herein, these terms shall include any and all other computer peripherals used for positing a cursor and/or entering commands into a computer.

The present invention solves problems in the art by providing an apparatus that allows a handheld computer peripheral, such as a computer mouse, to have a soft, pliable outer cover so that when a user engages the computer peripheral with a hand, the computer peripheral compresses at the locations where parts of the hand touch the computer peripheral, and then the outer cover returns to its original configuration once the hand is removed.

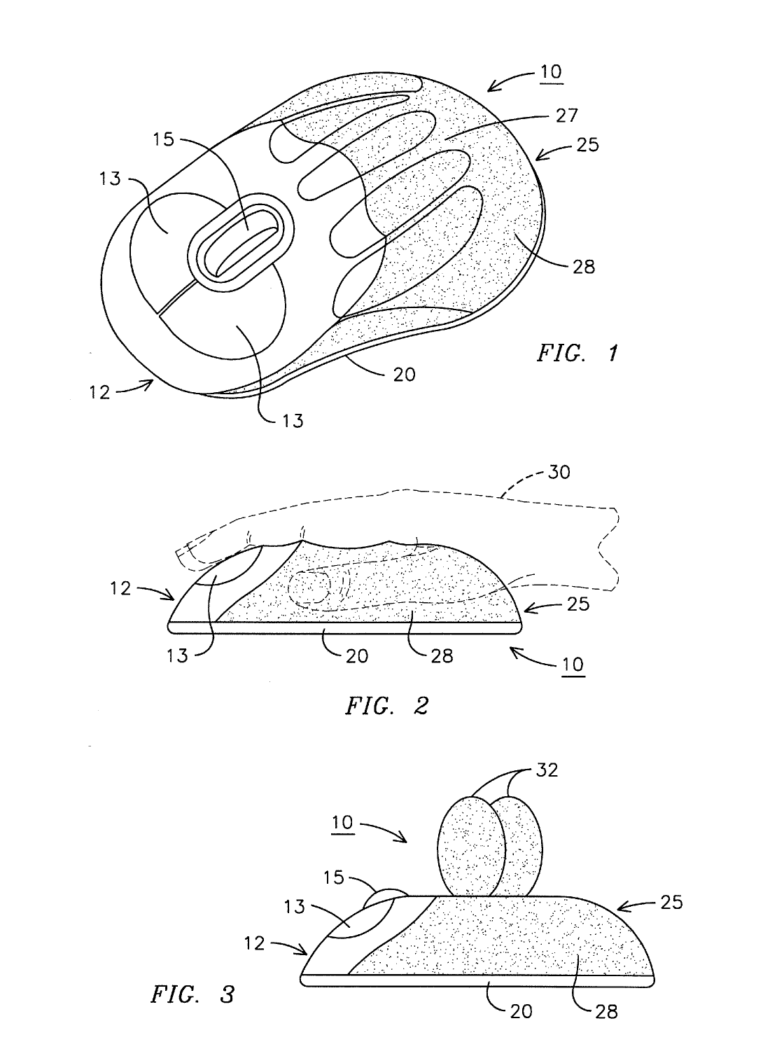

FIG. 1 depicts an exemplary embodiment of a computer peripheral with memory foam on its outer surface. The computer peripheral 10 illustrated is a computer mouse. A first part 12 of the peripheral 10 has a hard surface where at least once control button 13 is included. As illustrated, two control elements, such as in the form of buttons, 13 are provided. Also provided in the first part 12 is a scroll control element 15 that is used to provide further control to a user. The control buttons 13 and/or a scroll control 15 are positioned so that fingers are accessible to these control buttons 13, 15. The connection between the control buttons 13, 15 and the computer may be accomplished via wire, as well as wireless communications, such as, but not limited to, electromagnetic signal, Blue Tooth technology, and infrared technology.

A bottom housing 20 is also provided. The bottom housing 20 is made of a hard surface. The bottom housing 20 may also include a multi-directional device, such as but not limited to an inverted track ball, light-emitting diode and photodiodes, etc. to determine movement of the peripheral upon a surface.

A second part 25 of the peripheral 10 is generally configured to accommodate a plurality of human hands to be able to grip. The second part 25 is moldable and/or configurable to the hand. In one exemplary embodiment the outer cover 27 is moldable. The depth of the cover 27 may vary based on design goals. In another exemplary embodiment, all of the second part 25 is moldable. In an exemplary embodiment, the moldable part 25 is made of a foam. Thus, when the user places a hand upon the device 12 to use the device 12, the memory foam conforms to the user's hand. By doing so, the risk of injuries, such as carpal tunnel syndrome, resulting from repetitively using the peripheral 10, are reduced. When the user has removed his/her hand, the outer covering 27 to the peripheral 10 returns to its original form.

An exemplary type of foam used is memory foam 28. Those skilled in the art will recognize that other types of foam may also be used instead of the memory foam disclosed herein. Memory foam 28 is made from polyurethane with additional chemicals that add to its viscosity level, thereby increasing the density of the foam. It is often referred to as visco-elastic polyurethane foam. Depending on the chemicals used and the overall density of the foam, it can be firmer in cooler temperatures and softer in warmer environments. Higher density memory foam will react with body heat and allow it to mold itself to the shape of a warm body within a few minutes. However, a lower density memory foam is pressure-sensitive and will mold more quickly to the shape of the body. Such memory foam may include, but is not limited to, Tempur® foam.

Other forms of moldable material may also be utilized. The moldable material though should not require a user to apply too much pressure to the peripheral as such pressure over time may result in an injury. Towards this end, the moldable material likely is a type that will not instantaneously return to its original form, but may take, at a minimum, several seconds to return to its original form since such a material is not supposed to provide too much pressure against the hand when the hand is handling the peripheral.

FIG. 2 depicts an exemplary embodiment of the present invention with a hand 30 in place. As further illustrated, the division between the first part 12 and the second part 25 may be adjusted based on design requirements. For example the second part 25 may include a majority of the surface or the first part 12 may include a majority of the surface. As illustrated, the majority of the surface of the peripheral includes memory foam 28.

FIG. 3 depicts an exemplary embodiment of another computer peripheral with memory foam preformed into a particular configuration. As illustrated, the memory foam 28 is configured to include mouse ears 32. Those skilled in the art will readily recognize that other protrusions and/or body configurations may be used for a mouse computer peripheral. When the user applies the hand 30 to the peripheral, the memory foam 28 conforms to the user's hand 30, such as by the ears 32 laying either forward or backward wherein the ears 32 are compressed into the second part 25 of the peripheral 10 where the base of the ears are attached. When the user removes his/her hand 30, the memory foam 28 reverts to its original form. Thus, if elements protrude from the memory foam, such as ears, they are pressed into the rest of the body when the hand is in place. The ears then return to their standing position once the hand is removed. In another exemplary embodiment the shape of the may have a plurality of different shapes, such as being shaped to look like a character, such as a cartoon character, symbol, such as a business trademark or a sports team emblem, etc.

While exemplary embodiment of the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A computer peripheral, comprising:
(a) a body;
(b) a surface on the body having at least a part of the surface that conforms to an external force applied to the surface and returns to an original shape once the external force is removed;
(c) at least one control element disposed at a first location upon the surface; and
(d) a directional determining device disposed at a second location upon the surface.

2. The computer peripheral according to claim 1, wherein a non-conforming surface is provided beneath the part of the surface that conforms.

3. The computer peripheral according to claim 1, wherein the surface comprises elements that extend from the body to create at least one of a shape and a representation of at least one of a character and a symbol.

4. The computer peripheral according to claim 1, wherein the surface that conforms comprises memory foam.

5. The computer peripheral according to claim 1, wherein the part of the body where the at least one control element and the directional determining device is made of at least one of rigid material and nearly-rigid material.

6. The computer peripheral according to claim 1, wherein part of the surface that conforms to an external force comprises a material that provides minimum pressure against the external force applied so that when the pressure is removed the material does not instantaneously return to the original form.

7. A computer peripheral, the peripheral comprising:
(a) a main body having at least a first part, a second part and a bottom;
(b) a control element disposed at the first part of the main body;
(c) a moldable surface disposed at the second part of the main body; and
(d) wherein the moldable surface conforms to a hand placed upon the main body and returns to an original shape when the hand is removed.

8. The computer peripheral according to claim 7, wherein a non-moldable surface is provided beneath the moldable surface upon which the moldable surface is attached.

9. The computer peripheral according to claim 7, wherein the moldable surface comprises elements that extend from the main body to create at least one of a shape and a representation of at least one of character and symbol.

10. The computer peripheral according to claim 7, wherein the moldable surface comprises memory foam.

11. The computer peripheral according to claim 7, wherein the first part of the main body is comprised of at least one of a rigid and nearly rigid material.

12. The computer peripheral according to claim 7, wherein the moldable surface comprises a material that provides minimum pressure to the hand when the peripheral is being used so that once the hand is removed the material does not instantaneously return to the original form.

13. A computer peripheral comprising a cover structure upon which a hand is placed that is moldable to a contour of the hand when the hand is placed upon the peripheral and then returns to an original form of the cover structure when the hand is removed from the peripheral.

14. The computer peripheral according to claim 13, further comprising a non-moldable part of the cover structure for locating a control element.

15. The computer peripheral according to claim 14 wherein the non-moldable part is made of at least one of a rigid material and a nearly rigid material.

16. The computer peripheral according to claim 13, wherein a non-moldable surface is provided beneath the cover structure upon which the cover structure is attached.

17. The computer peripheral according to claim 13, wherein the moldable part comprises memory foam.

18. The computer peripheral according to claim 13, wherein the moldable part further comprises elements that extend from the main body to create at least one of a shape and a representation of at least one of character and symbol.

19. The computer peripheral according to claim 13, wherein the moldable part comprises a material that provides minimum pressure to the hand when the peripheral is being used so that when the hand is removed the material does not instantaneously return to the original form.
